(19) United States
(12) Patent Application Publication
(10) Pub. No.: US 2025/0277891 A1
(43) Pub. Date: Sep. 4, 2025

(54) FREQUENCY MODULATED CONTINUOUS WAVE RADAR WITH IDENTITY RECOGNITION FUNCTION AND METHOD FOR DECODING IDENTITY CODE FROM RADAR ECHO

(71) Applicant: Wistron Corporation, New Taipei City (TW)

(72) Inventor: Yao-Tsung CHANG, New Taipei City (TW)

(21) Appl. No.: 18/651,440

(22) Filed: Apr. 30, 2024

(30) Foreign Application Priority Data
Feb. 29, 2024 (TW) 113107323

(51) Int. Cl. G01S 7/41; G01S 7/35; G01S 13/32

(52) U.S. Cl. CPC G01S 7/411; G01S 7/354; G01S 7/356; G01S 13/32

(57) ABSTRACT

A frequency modulated continuous wave (FMCW) radar with an identity recognition function and a method for decoding an identity code from a radar echo are provided. After digital signals corresponding to the radar echo detected by the FMCW radar are obtained, a range fast Fourier transform (FFT) process is applied to the digital signals to obtain a plurality of peak frequencies. Subsequently, the peak frequencies are converted into a plurality of delay times based on a linear frequency-modulated (LFM) slope. Finally, an identity code is calculated based on the delay times.

### CROSS-REFERENCE TO RELATED APPLICATION

This non-provisional application claims priority under 35 U.S.C. § 119 (a) to patent application No. 113107323 filed in Taiwan, R.O.C. on Feb. 29, 2024, the entire contents of which are hereby incorporated by reference.

### BACKGROUND

### Technical Field

The present invention relates to a frequency modulated continuous wave (FMCW) radar, and in particular, to an FMCW radar with an identity recognition function and a method for decoding an identity code from a radar echo.

### Related Art

Currently, the radar technology may be used to detect physiological information and a body temperature. However, to know which subject measurement information comes from, only a subject can be asked to wear an additional identity recognition device, for example, an e-tag or an RFID tag. This not only incurs an additional cost for the identity recognition device, but also causes inconvenience and discomfort for the subject as a result of wearing the identity recognition device.

### SUMMARY

In view of this, an embodiment of the present invention provides a frequency modulated continuous wave (FMCW) radar with an identity recognition function. The FMCW radar includes a processing module and an operation module. The processing module is configured to demodulate a radar echo corresponding to a radar signal to generate a digital signal. The operation module is coupled to the processing module and configured to: apply a range fast Fourier transform (FFT) process to the digital signal to obtain a plurality of peak frequencies; convert the peak frequencies into a plurality of delay times based on a linear frequency modulation (LFM) slope; and calculate an identity code based on the delay times.

An embodiment of the present invention provides a method for decoding an identity code from a radar echo, performed by an operation device. The method for decoding an identity code from a radar echo includes: obtaining a digital signal; applying a range FFT process to the digital signal to obtain a plurality of peak frequencies; converting the peak frequencies into a plurality of delay times based on an LFM slope; and calculating an identity code based on the delay times.

According to the FMCW radar with an identity recognition function and the method for decoding an identity code from a radar echo of some embodiments of the present invention, the identity code may be obtained by using a radar echo of a sensor already worn by a subject and existing in a same radar system, without the need for the subject to wear an additional identity recognition device that does not belong to the radar system. Moreover, in addition to identity recognition, sensing information and vital sign information of the sensor may be detected through the same radar system.

### BRIEF DESCRIPTION OF THE DRAWINGS

FIG. 1 is a schematic diagram of a frequency modulated continuous wave (FMCW) radar according to an embodiment of the present invention.

FIG. 2 is a schematic diagram of processing of a digital signal according to an embodiment of the present invention.

FIG. 3A is a schematic diagram of a radar signal according to an embodiment of the present invention.

FIG. 3B is a schematic diagram of demodulation of a radar echo according to an embodiment of the present invention.

FIG. 3C is a schematic diagram of a frequency domain of a digital signal after being processed according to an embodiment of the present invention.

FIG. 3D is a schematic diagram of a time domain of a digital signal after being processed according to an embodiment of the present invention.

FIG. 4 is a schematic diagram of a sensor according to an embodiment of the present invention.

FIG. 5A is a schematic diagram of a coding layout of a sensor according to an embodiment of the present invention.

FIG. 5B is a schematic diagram of decoding of a frequency domain according to an embodiment of the present invention.

FIG. 5C is a schematic diagram of decoding of a time domain according to an embodiment of the present invention.

FIG. 6 is a schematic diagram of a coding layout of a sensor according to another embodiment of the present invention.

FIG. 7 is a schematic diagram of a radar signal using two chirp signals according to an embodiment of the present invention.

FIG. 8 is a schematic diagram of a radar signal using two chirp signals according to another embodiment of the present invention.

FIG. 9 is a flowchart of a method for performing identity recognition by using a radar according to an embodiment of the present invention.

FIG. 10 is a flowchart of a method for decoding an identity code from a radar echo according to an embodiment of the present invention.

FIG. 11 is a detailed flowchart of a method for decoding an identity code from a radar echo according to an embodiment of the present invention.

FIG. 12 is a detailed flowchart of a method for decoding an identity code from a radar echo according to another embodiment of the present invention.

### DETAILED DESCRIPTION

To facilitate understanding of technical features, contents, advantages, and achievable effects of the present invention, this specification is described in detail below in the form of embodiments with reference to accompany drawings. A main purpose of the drawings used therein is only for illustration and assistance with the specification, and may not necessarily be an actual proportion and precise configuration after implementation of the present invention. Therefore, the proportions and configuration relationships of the attached drawings should not be interpreted to limit the scope of claims in actual implementation of the present invention.

The same reference numerals are used to indicate the same or similar elements in all of the drawings. The term “include” mentioned in this specification is an open term and therefore should be interpreted as “include but not limited to”. The term “coupling” used herein means that two or more elements are “directly” in physical or electrical contact with each other, or “indirectly” in physical or electrical contact with each other. Terms such as “first” and “second” used herein are used to distinguish between referred elements, rather than being used to sort the referred elements or limit differences in the referred elements or limit the scope of the present invention unless otherwise specified.

When space-related narrative words such as “under . . . ”, “low”, “down”, “above”, “up”, “on . . . ” and similar words are used, for ease of description, usages thereof are all to describe a relative relationship between one element or feature and another (or a plurality of) element(s) or feature(s) in the drawings. In addition to angles and directions displayed in the drawings, the space-related words are also used to describe possible angles and directions of a device during use and operation. The angles and directions of the device may be different (rotated by 90 degrees or at another orientation), and the space-related descriptions used herein may be interpreted in the same way.

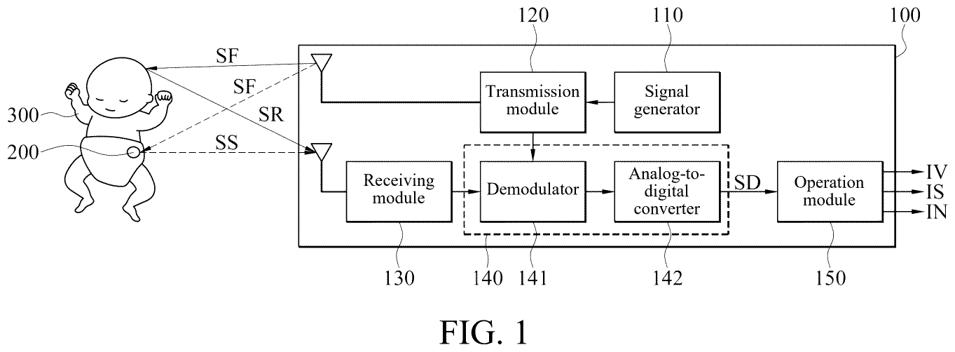

Refer to FIG. 1. FIG. 1 is a schematic diagram of a frequency modulated continuous wave (FMCW) radar 100 according to an embodiment of the present invention. The FMCW radar 100 includes a signal generator 110, a transmission module 120, a receiving module 130, a processing module 140, and an operation module 150. The signal generator 110 is configured to generate a linear frequency-modulated (LFM) radar signal SF. The transmission module 120 is coupled to the signal generator 110 and configured to transmit the radar signal SF. The transmission module 120 is a transmitter. The transmitter has basic elements of a transmitter such as a transmission antenna and a power amplifier. The receiving module 130 is configured to receive radar echoes SR and SS corresponding to the radar signal SF. The receiving module 130 is a receiver. The receiver has basic elements of a receiver such as a receiving antenna, a low noise amplifier (LNA), and a filter circuit. The processing module 140 is coupled to the receiving module 130, and configured to demodulate the radar echoes SR and SS to generate digital signals SD. Specifically, the processing module 140 includes a demodulator 141 and an analog-to-digital converter 142. The demodulator 141 is coupled to the transmission module 120 and the receiving module 130 and configured to demodulate the radar echo SR to generate an intermediate frequency (IF) signal based on the radar signal SF. The analog-to-digital converter 142 is coupled to the demodulator 141 and configured to perform analog-to-digital conversion on the IF signal to obtain the digital signals SD. The operation module 150 is coupled to the processing module 140 and configured to analyze the digital signals SD to obtain relevant information (including at least one of vital sign information IV, sensing information IS, and an identity code IN). The operation module 150 may be implemented through a processor, a complex programmable logic device (CPLD), a field-programmable gate array (FPGA), a logic circuit, an analog circuit, a digital circuit, and/or any processing element that processes a signal (analog and/or digital) based on an operation instruction.

For the convenience of the following description, FIG. 1 illustrates that after the radar signal SF is transmitted to a sensor 200 and a creature 300, the radar echo SS corresponding to the radar signal SF is generated from the sensor 200, the radar echo SR corresponding to the radar signal SF is generated from the creature 300, and the receiving module 130 receives the radar echoes SR and SS. The radar echo SR is generated by reflection from an object (which is the creature 300 herein). It should be noted that FIG. 1 does not mean that no other radar echoes SR are generated from other objects (for example, a wall and a ground), but only means that the radar echo SR is not a signal to be analyzed in the present invention and therefore is not intentionally mentioned. In addition, not only the sensor 200 and the creature 300 that are shown exist in a detection field. In other words, in some cases, the detection field includes more or fewer to-be-detected targets, and a type of the to-be-detected target is not limited to the type shown in FIG. 1. For example, the creature 300 may be any human or animal. The to-be-detected target refers to an object to be detected through the radar signal SF, which depends on a detection purpose. For example, if vital sign information IV (such as breathing and heartbeats) of the creature 300 is to be detected, the creature 300 is the to-be-detected target. If sensing information IS and/or an identity code IN of the sensor 200 are to be detected, the sensor 200 is the to-be-detected target.

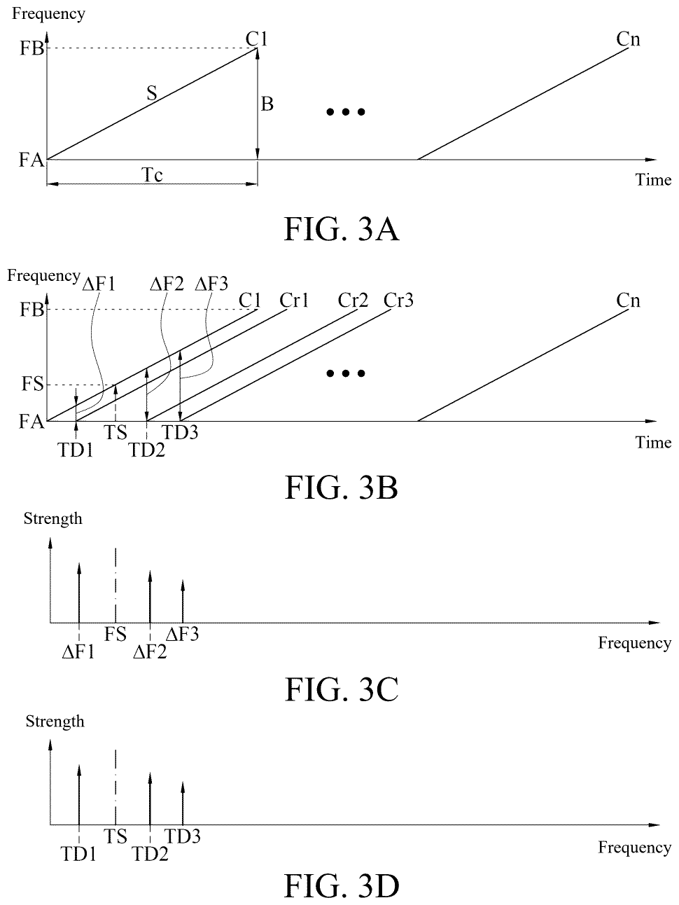

Refer to FIG. 3A. FIG. 3A is a schematic diagram of a radar signal SF according to an embodiment of the present invention. The radar signal SF includes a plurality of chirp signals C1-Cn, where n is a positive integer. Herein, the chirp signals C1-Cn are linearly frequency-modulated, and frequencies thereof increase linearly over time. As shown in FIG. 3A, within a cycle time Tc, the chirp signals C1-Cn linearly increase from a starting frequency FA to an ending frequency FB based on a slope S. A difference between the starting frequency FA and the ending frequency FB is an operation bandwidth B. The slope S is a ratio of the operation bandwidth B to the cycle time Tc. For example, if the starting frequency is 24 GHZ, the ending frequency is 26 GHZ, and the cycle time Tc is 40 μs, the operation bandwidth B is 2 GHz, and the slope S is 50 MHz/μs.

Refer to FIG. 3B. FIG. 3B is a schematic diagram of demodulation of a radar echo SR according to an embodiment of the present invention. An example in which radar echoes SR and SS each include three chirp echoes Cr1, Cr2, and Cr3 is used for illustration herein. The chirp echoes Cr1, Cr2, and Cr3 may be considered as delayed versions of a chirp signal C1, and respectively have delay times TD1, TD2, and TD3. A demodulation process in which a demodulator 141 generates the foregoing IF signal is further described herein. Demodulation of the chirp echo Cr1 is used as an example. In some embodiments, the demodulator 141 includes a mixer coupled to a transmission module 120 and a receiving module 130. The mixer couples the chirp signal C1 and the chirp echo Cr1 to generate a coupled signal (that is, an IF signal) with a frequency difference between the chirp signal and the chirp echo. The frequency difference herein is a frequency difference ΔF1. The chirp echoes Cr2 and Cr3 are demodulated in the same manner, to respectively obtain IF signals with frequency differences ΔF2 and ΔF3.

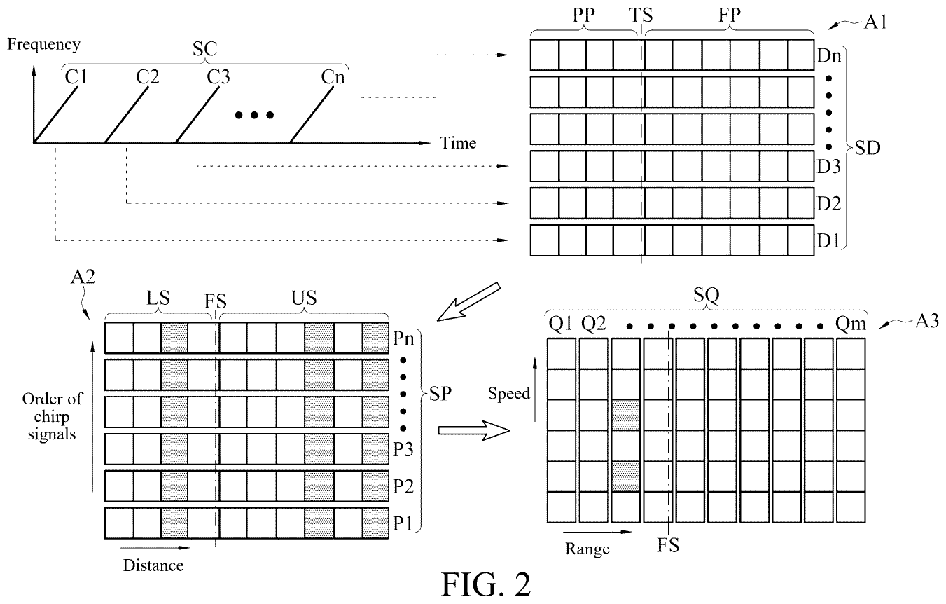

Refer to FIG. 2. FIG. 2 is a schematic diagram of processing of digital signals SD according to an embodiment of the present invention. Herein, chirp signals SC are numbered as C1, C2, C3, . . . , and Cn in sequence, where n is a positive integer. An analog-to-digital converter 142 converts IF signals corresponding to the chirp signals C1-Cn into digital signals SD (which are respectively expressed as D1, D2, D3, . . . , and Dn, where n is a positive integer). Numerical values of the digital signals SD may be expressed as a one-dimensional array (arranged in rows). The rows are arranged in a longitudinal direction in sequence to form a matrix A1. A value of the matrix A1 represents a signal strength (an amplitude). A vertical-axis index value of the matrix A1 corresponds to an order of the chirp signals SC, that is, covers a period of a plurality of chirp signals SC, which may express information about a slow time. A horizontal-axis index value of the matrix A1 corresponds to a cycle time Tc of the chirp signals SC, which may express information about a fast time.

A “range fast Fourier transform (FFT) process” to be mentioned below is described herein, which is to perform FFT on each row of the matrix A1. A conversion result generated by the range FFT process is a matrix A2 in FIG. 2. Rows of the matrix A2 are frequency domain signals SP (which are respectively expressed as P1, P2, P3, . . . , and Pn, where n is a positive integer) corresponding to the digital signals D1-Dn. A vertical-axis index value of the matrix A2 still corresponds to an order of the chirp signals SC. As shown in FIG. 3B, a ratio of the frequency difference ΔF1 to the delay time TD1 is a slope S. Since the slope S is known, the delay time TD1 may be calculated through the frequency difference ΔF1. Furthermore, a radar transmission speed is also known (an electromagnetic wave transmission speed is a speed of light), and a transmission distance of a chirp echo Cr1 may be calculated through the delay time TD1. In other words, the IF signal contains distance information. To be specific, the horizontal-axis index value of the matrix A2 may represent the distance information. The values of the matrix A2 represent strengths of frequencies on a spectrum, which may present strengths of radar echoes SR generated at different distances from an FMCW radar 100. In an example, colored boxes in the matrix A2 represent peaks. A distance index value corresponding to each of the peaks is equivalent to a distance between a to-be-detected target and the FMCW radar 100.

A “Doppler FFT process” to be mentioned below is described herein, which is to perform FFT on each column of the matrix A2. A conversion result generated by the Doppler FFT process is a matrix A3 in FIG. 2. Columns of the matrix A3 are respectively phase frequency domain signals SQ (which are respectively expressed as Q1, Q2, . . . , and Qm, where m is a positive integer). A phase difference between every two adjacent chirp signals SC may be obtained from the phase frequency domain signals SQ, so as to calculate a speed or a periodic motion frequency. To be specific, a vertical-axis index value of the matrix A3 may represent speed information. In an example, colored boxes in the matrix A3 represent peaks. A movement speed of the to-be-detected target or frequency information (such as vital sign information IV such as breathing and heartbeats) of periodic motion may be calculated based on a speed index value corresponding to each of the peaks. A horizontal-axis index value of the matrix A3 also represents distance (range) information.

Refer to FIG. 3C. FIG. 3C is a schematic diagram of a frequency domain of digital signals SD after being processed according to an embodiment of the present invention. The processing is the foregoing range FFT process. It may be seen that after the IF signal in FIG. 3B is processed through the range FFT process, a spectrum distribution of frequency differences ΔF1, ΔF2, and ΔF3 is formed.

Refer to FIG. 3D. FIG. 3D is a schematic diagram of a time domain of digital signals SD after being processed according to an embodiment of the present invention. As shown in FIG. 3B, a ratio of each of the frequency differences ΔF1, ΔF2, and ΔF3 to each of the delay times TD1, TD2, and TD3 is the slope S. Therefore, frequency differences ΔF1, ΔF2, and ΔF3 in FIG. 3C may be converted into a time domain distribution with the delay times TD1, TD2, and TD3 (as shown in FIG. 3D).

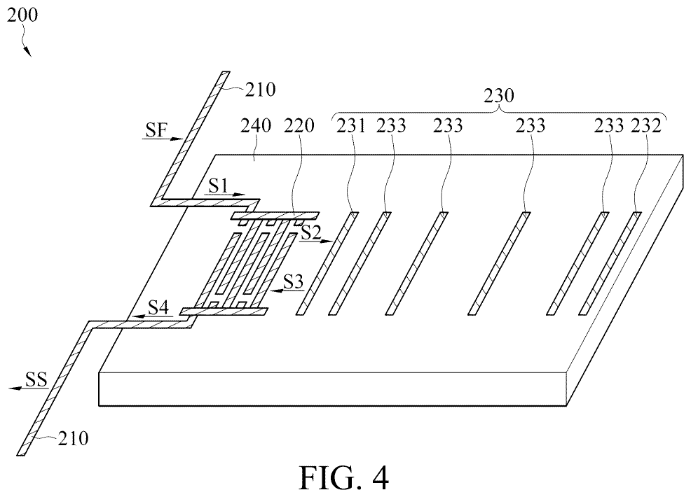

Refer to FIG. 4. FIG. 4 is a schematic diagram of a sensor 200 according to an embodiment of the present invention. The sensor 200 is a passive surface acoustic wave (SAW) sensor. The sensor 200 includes an antenna 210, a transducer 220, a plurality of reflectors 230, and a piezoelectric substrate 240. When the sensor 200 receives the foregoing radar signal SF, the sensor may return a corresponding radar echo SS. In some embodiments, the transducer 220 is an interdigital transducer (IDT). The antenna 210, the transducer 220, and the reflector 230 are made of metal materials. The piezoelectric substrate 240 is a substrate made of a piezoelectric material.

Specifically, when the antenna 210 receives the radar signal SF, a first electric signal S1 is generated based on the radar signal SF. The transducer 220 is coupled to the antenna 210 and arranged on the piezoelectric substrate 240. Through a reverse piezoelectric effect of the piezoelectric substrate 240, the transducer 220 converts the first electric signal S1 into a first SAW signal S2 transmitted toward the reflector 230. Next, when the first SAW signal S2 touches the reflector 230, a second SAW signal S3 is generated through a piezoelectric effect of the piezoelectric substrate 240 and is transmitted to the transducer 220. This action is referred to as “acoustic wave reflection” for short later. The transducer 220 subsequently converts the second SAW signal S3 into a second electric signal S4 through the piezoelectric effect of the piezoelectric substrate 240. Finally, the antenna 210 transmits a radar echo SR to the FMCW radar 100 based on the second electric signal S4. It should be noted herein that the first SAW signal S2 is successively reflected through the acoustic wave reflection of the reflectors 230, and a plurality of second SAW signals S3 are successively generated accordingly. Finally, a plurality of corresponding radar echoes SS are returned to the FMCW radar 100. Therefore, an identity code IN may be determined based on a position of each reflector 230 arranged on the piezoelectric substrate 240.

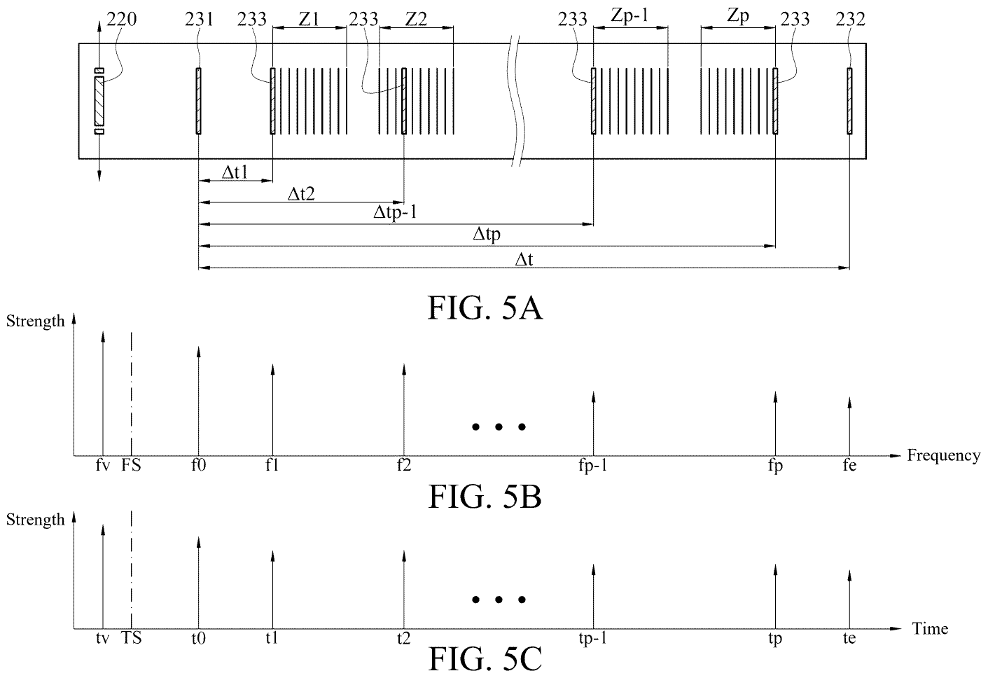

FIG. 5A is a schematic diagram of a coding layout of a sensor 200 according to an embodiment of the present invention. Reflectors 230 include a first reflector 231, a second reflector 232, and a plurality of coding reflectors 233. The first reflector 231, the second reflector 232, and the plurality of coding reflectors 233 are arranged in an axial direction. The axial direction is a transmission direction of the foregoing first SAW signal S2 and second SAW signal S3. The first reflector 231, the second reflector 232, and the plurality of coding reflectors 233 are all in the shape of a line, and long axes thereof are perpendicular to the foregoing axial direction. However, the reflectors 230 are not limited to be in the shape of the line, and the arrangement thereof is not limited to be in the axial direction, as long as the foregoing acoustic wave reflection effect can be achieved. The first reflector 231 is arranged on a side adjacent to the transducer 220, the second reflector 232 is arranged on a side away from the transducer 220, and the coding reflectors 233 are arranged between the first reflector 231 and the second reflector 232. The coding reflectors 233 are respectively located in sections Z1, Z2, Zp−1, and Zp, where p is a positive integer. Each of the sections Z1, Z2, Zp−1, and Zp is assigned a plurality of code positions (which are represented by thin lines), and each of the coding reflectors 233 is arranged in one of the code positions. The code positions respectively represent digits from left to right. 10 code positions are used as an example, which respectively represent 0 to 9. In this way, the digits represented by the coding reflectors 233 may be combined into a code (the code is used for a purpose of identity recognition, and is also referred to as an identity code IN) based on arrangement positions of the coding reflectors 233. For example, codes shown in FIG. 5A are 04, . . . , and 09.

In some embodiments, a spacing between the sections Z1, Z2, Zp−1, and Zp is greater than a spacing between the code positions, to effectively avoid a measurement error. In some embodiments, a spacing between the sections Z1, Z2, Zp−1, and Zp is several times a spacing between the code positions.

Refer to FIG. 5B. FIG. 5B is a schematic diagram of decoding of a frequency domain according to an embodiment of the present invention. When an FMCW radar 100 receives a radar echo SS from a sensor 200, peak frequencies f0, f1, f2, fp−1, fp, and fe in FIG. 5B are formed through the foregoing processing such as demodulation, analog-to-digital conversion, and range FFT process. The radar echo SS generated in response to acoustic wave reflection of a first reflector 231 is processed as the peak frequency f0. The radar echo SS generated in response to acoustic wave reflection of a second reflector 232 is processed as the peak frequency fe. The radar echoes SS generated in response to acoustic wave reflection of coding reflectors 233 are processed as the peak frequencies f1, f2, fp−1, and fp.

Refer to FIG. 5C. FIG. 5C is a schematic diagram of decoding of a time domain according to an embodiment of the present invention. Based on the foregoing conversion relationship between FIG. 3C and FIG. 3D, the peak frequencies f0, f1, f2, fp−1, fp, and fe in FIG. 5B may also be respectively converted into delay times t0, t1, t2, tp−1, tp, and te by using a slope S.

Refer to FIG. 5A and FIG. 5C together. A difference between the delay time to and the delay time t1 is a time difference Δt1, which is mainly determined by a distance between the first reflector 231 and the coding reflector 233 in a section Z1 (the difference and the distance are positively correlated). Similarly, a difference (a time difference Δt2) between the delay time to and the delay time t2 is positively correlated with a distance between the first reflector 231 and the coding reflector 233 in a section Z2, and so on. In this way, time differences Δt2, Δtp−1, Δtp, and Δt may be obtained, which are respectively related to a position of the coding reflector 233 or the second reflector 232 that causes the corresponding acoustic wave reflection. For the convenience of subsequent description, the delay time to related to the first reflector 231 that causes the corresponding acoustic wave reflection is referred to as a first reference time, the delay time the related to the second reflector 232 that causes the corresponding acoustic wave reflection is referred to as a second reference time, and the delay times t1-tp related to the coding reflector 233 that causes the corresponding acoustic wave reflection are referred to as mark times. A difference between each mark time and the first reference time is referred to as a first difference, and a difference between the first reference time and the second reference time is referred to as a second difference.

Refer to Table 1. In an example, time differences (in microsecond) caused by the coding reflectors 233 at code positions are listed, which respectively correspond to digits represented by the code positions. In this example, the time difference Δt is 10 microseconds. Therefore, through pre-establishment of a comparison table, the corresponding digits are found based on the time differences Δt1-Δtp related to the coding reflectors 233 that cause the corresponding acoustic wave reflection, and are decoded into an identity code IN.

TABLE 1

| | 0 | 1 | 2 | 3 | 4 | 5 | 6 | 7 | 8 | 9 |
|---|---|---|---|---|---|---|---|---|---|---|
| Δt1 | 1.0 | 1.05 | 1.1 | 1.15 | 1.2 | 1.25 | 1.3 | 1.35 | 1.4 | 1.45 |
| Δt2 | 2.0 | 2.05 | 2.1 | 2.15 | 2.2 | 2.25 | 2.3 | 2.35 | 2.4 | 2.45 |
| Δt3 | 3.0 | 3.05 | 3.1 | 3.15 | 3.2 | 3.25 | 3.3 | 3.35 | 3.4 | 3.45 |
| Δt4 | 4.0 | 4.05 | 4.1 | 4.15 | 4.2 | 4.25 | 4.3 | 4.35 | 4.4 | 4.45 |
| Δt5 | 5.0 | 5.05 | 5.1 | 5.15 | 5.2 | 5.25 | 5.3 | 5.35 | 5.4 | 5.45 |
| Δt6 | 6.0 | 6.05 | 6.1 | 6.15 | 6.2 | 6.25 | 6.3 | 6.35 | 6.4 | 6.45 |
| Δt7 | 7.0 | 7.05 | 7.1 | 7.15 | 7.2 | 7.25 | 7.3 | 7.35 | 7.4 | 7.45 |
| Δt8 | 8.0 | 8.05 | 8.1 | 8.15 | 8.2 | 8.25 | 8.3 | 8.35 | 8.4 | 8.45 |

However, in some embodiments, some environmental factors (for example, a temperature) may affect a SAW propagation speed, thereby resulting in a deviation of the obtained time differences Δt1-Δtp from those in Table 1, and the corresponding numerical values cannot be found in Table 1. Therefore, the numerical values in Table 1 may be normalized, and the numerical value of each of the time differences Δt1-Δtp in Table 1 is divided by the time difference Δt to eliminate environmental impact factors. Correspondingly, after the time differences Δt1-Δtp and Δt measured by the radar are obtained, the identity code IN is calculated based on a ratio of each first difference (that is, each of the time differences Δt1-Δtp) to the second difference (that is, the time difference Δt). Then the normalized Table 1 is searched for the identity code IN based on the calculated ratio.

In some embodiments, the positions of the first reflector 231 and the second reflector 232 are not limited to those in the foregoing embodiments. For example, the position of the second reflector 232 may be located between the coding reflectors 233, as long as relative positions of both the first reflector 231 and the second reflector 232 can be clearly defined.

In some embodiments, the first reflector 231 and the second reflector 232 may be further used for sensing besides providing the normalization effect. As described above, the environmental factors may affect the SAW propagation speed. Since the distance between the first reflector 231 and the second reflector 232 is certain, a measurement value (that is, sensing information IS) of the corresponding environmental factor may be estimated through a variation of the measured second difference (that is, the time difference Δt). The environmental factors include but are not limited to a temperature, a humidity, a pressure, or a chemical composition. Depending on the environmental factor measured by the sensor 200, the measurement value is positively or negatively correlated with the second difference.

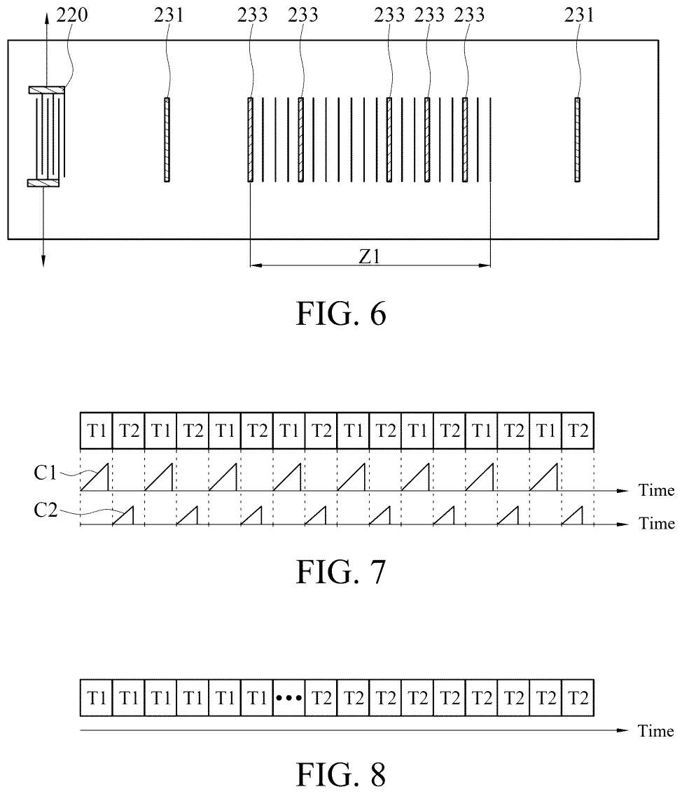

Refer to FIG. 6. FIG. 6 is a schematic diagram of a coding layout of a sensor 200 according to another embodiment of the present invention. Herein, the coding layout is implemented through binary coding. A section Z1 includes a plurality of code positions (represented by thin lines). A code position where a coding reflector 233 is arranged is represented as a binary 1. Otherwise, the code position is represented as 0. In some embodiments, a code position where a coding reflector 233 is arranged is represented as a binary 0. Otherwise, the code position is represented as 1. In this way, a digital representation corresponding to the coding reflector 233 may also be found based on the foregoing relevant description in FIG. 5, to decode the identity code IN.

It should be noted that propagation speeds of the radar signal SF and the radar echo SR reflected by an object are transmission speeds of electromagnetic waves, which are almost equal to a speed of light. However, propagation speeds of the first SAW signal S2 and the second SAW signal S3 are only substantially equal to a general sound speed, so that the radar echo SS transmitted by the sensor 200 may form a significantly long delay time (usually at a microsecond level). Relatively speaking, a delay time of the radar echo SR of the radar signal SF reflected by an object is only 10 nanoseconds. To be specific, a time point at which a receiving module 130 receives the radar echo SR reflected by the object is obviously earlier than a time point at which the receiving module receives the radar echo SS transmitted by the sensor 200. Therefore, as shown in FIG. 5C, through a time separation point TS, a delay time tv calculated based on the radar echo SR may be distinguished from the delay times t0, t1, t2, tp−1, tp, and the calculated based on the radar echo SS. In some embodiments, the time separation point TS is selected from a range of 100 nanoseconds to 1 microsecond.

As described above, the conversion relationship exists between FIG. 5B and FIG. 5C. Therefore, through a frequency separation point FS, a peak frequency fv calculated based on the radar echo SR may be distinguished from the peak frequencies f0, f1, f2, fp−1, fp, and fe calculated based on the radar echo SS (as shown in FIG. 5B).

FIG. 7 is a schematic diagram of a radar signal SF using two chirp signals C1 and C2 according to an embodiment of the present invention. As shown in FIG. 7, a time axis includes a plurality of first time slots T1 and a plurality of second time slots T2. The first time slots T1 and the second time slots T2 are staggered with respect to each other, to achieve a design of time-division multiplexing. The chirp signals C1 and C2 of the radar signal SF are respectively located in the first time slot T1 and the second time slot T2. To be specific, the chirp signal C1 is located in the first time slot T1, and the chirp signal C2 is located in the second time slot T2. A difference exists between the chirp signal C1 and the chirp signal C2. The difference comes from different LFM parameters of at least one of an LFM slope S, a starting frequency FA, an ending frequency FB, an operation bandwidth B, and a cycle time Tc. Therefore, the chirp signals C1 and C2 with appropriate parameters may be selected for a specific detection purpose to enhance detection precision, detection sensitivity, a detection range, and the like. For example, in the first time slot T1, vital sign information IV is detected by using a radar echo SR corresponding to the chirp signal C1. In the second time slot T2, an identity code IN and sensing information IS are detected by using a radar echo SS corresponding to the chirp signal C2.

FIG. 8 is a schematic diagram of a radar signal SF using two chirp signals C1 and C2 according to another embodiment of the present invention. Compared with FIG. 7, in this example, the first time slots T1 appears continuously, and the second time slots T2 may also appear continuously. To be specific, in the continuous first time slots T1, one piece of information is detected by using a radar echo SR/SS corresponding to the chirp signal C1. In the continuous second time slots T2, another piece (or more pieces) of information is (are) detected by using a radar echo SR/SS corresponding to the chirp signal C2.

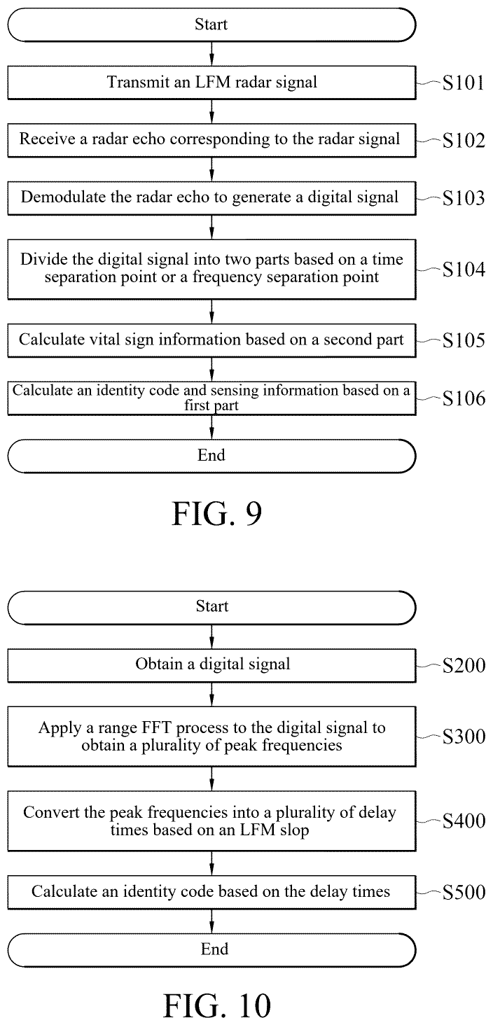

Refer to FIG. 9. FIG. 9 is a flowchart of a method for performing identity recognition by using a radar (that is, the foregoing FMCW radar 100) according to an embodiment of the present invention. Step S101: Transmit an LFM radar signal SF. Step S102: Receive radar echoes SR and SS corresponding to the radar signal SF. Step S103: Demodulate the radar echoes SR and SS to generate digital signals SD.
Step S104: Divide the digital signals SD into two parts (a first part and a second part) based on a time separation point TS or a frequency separation point FS. As shown in FIG. 2, the manner in which the digital signals SD are divided into two parts in the time domain shown in the matrix A1 is dividing the digital signals SD into a first side signal (the first part) and a second side signal (the second part) based on the time separation point TS. In some embodiments, the first side signal is a following portion signal FP, which is generated after the time separation point TS. The second side signal is a preceding portion signal PP, which is generated before the time separation point TS.

In addition, the manner in which the digital signals SD are divided into two parts (the first part and the second part) in the frequency domain shown in the matrix A2 is dividing the digital signals SD into a first sideband signal (the first part) and a second sideband signal (the second part) based on the frequency separation point FS. In some embodiments, the first sideband signal is an upper sideband signal US, which is generated after the frequency separation point FS. The second sideband signal is a lower sideband signal LS, which is generated before the frequency separation point FS.

As shown in FIG. 9, in step S105, vital sign information IV is calculated based on the second part. In some embodiments, the vital sign information IV such as breathing and heartbeats is calculated through time-domain and frequency-domain analysis of a range FFT process and a Doppler FFT process applied to the second part of the digital signals SD. In some embodiments, for a signal obtained based on the second part of the digital signals SD to which the range FFT process and the Doppler FFT process are applied, the corresponding vital sign information IV such as breathing and heartbeats is estimated by using an artificial intelligence machine learning algorithm. In some embodiments, based on the second part of the digital signals SD to which the range FFT process and the Doppler FFT process are not applied, the corresponding vital sign information IV such as breathing and heartbeats is estimated directly or by using an artificial intelligence machine learning algorithm after other preprocessing.
Step S106: Calculate an identity code IN and sensing information IS based on the first part. In some embodiments, a peak frequency is calculated through frequency domain analysis of the range FFT process applied to the first part of the digital signals SD, and the identity code IN and the sensing information IS are calculated accordingly. In some embodiments, the foregoing peak frequency calculated through the frequency domain analysis is converted based on an LFM slope to obtain a delay time, and the identity code IN and the sensing information IS are calculated accordingly. In some embodiments, for a signal obtained based on the first part of the digital signals SD to which the range FFT process is applied, the corresponding identity code IN and the sensing information IS are estimated by using an artificial intelligence machine learning algorithm. In some embodiments, based on the first part of the digital signals SD to which the range FFT process is not applied, the corresponding identity code IN and the sensing information IS are estimated directly or by using an artificial intelligence machine learning algorithm after other preprocessing.

In some embodiments, step S105 and step S106 may be performed in a reversed order or performed in parallel.

The foregoing artificial intelligence machine learning algorithm includes but is not limited to supervised learning, unsupervised learning, semi-supervised learning, or reinforcement learning.

FIG. 10 is a flowchart of a method for decoding an identity code from a radar echo according to an embodiment of the present invention. The method for decoding an identity code from radar echoes SR and SS is performed by an operation device. In some embodiments, the operation device is the operation module 150 of the foregoing FMCW radar 100. In some embodiments, the operation device is located outside the FMCW radar 100, and is an electronic device with a computing capability, for example, a computer, a cloud server, an embedded system, or an operation unit therein.
Step S200: Obtain digital signals SD through processing such as demodulation and analog-to-digital conversion of the radar echoes SR and SS by the FMCW radar 100. Step S300: Apply a range FFT process to the digital signals SD to obtain a plurality of peak frequencies (the peak frequencies f0, f1, f2, fp−1, fp, and fe as shown in FIG. 5B). Step S400: Convert the peak frequencies into a plurality of delay times (the delay times t0, t1, t2, tp−1, tp, and the as shown in FIG. 5C) based on an LFM slope. Step S500: Calculate an identity code IN based on the delay times by using the foregoing decoding method.

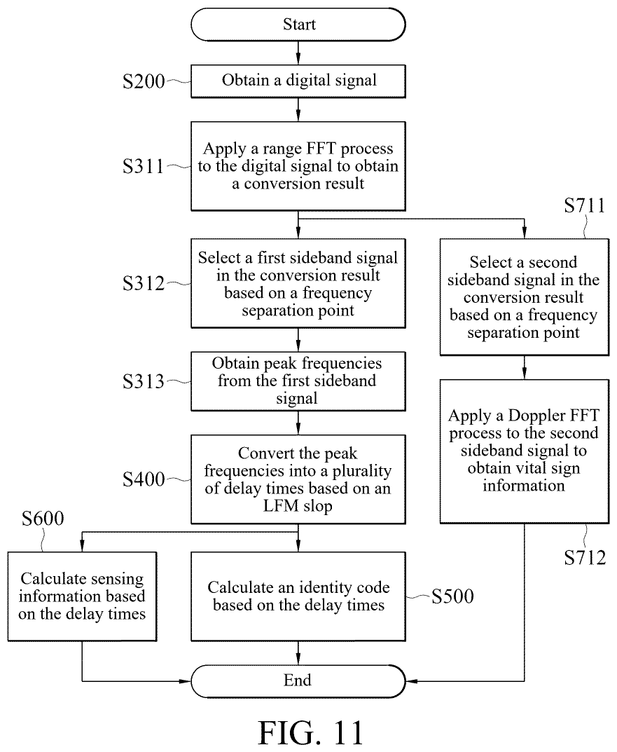

FIG. 11 is a detailed flowchart of a method for decoding an identity code from a radar echo according to an embodiment of the present invention. Refer to FIG. 2, FIG. 3C, and FIG. 11 together. Only a difference from FIG. 10 is described herein. The foregoing step S300 includes step S311 to step S313. In step S311, the range FFT process is applied to the digital signals SD to obtain a conversion result (the matrix A2 as shown in FIG. 2). In step S312, a first sideband signal (an upper sideband signal US) in the conversion result is selected based on a frequency separation point FS. In step S313, the peak frequencies (the frequency differences ΔF2 and ΔF3 as shown in FIG. 3C) are obtained from the first sideband signal (the upper sideband signal US).

Further, in step S711, a second sideband signal (a lower sideband signal LS) in the conversion result is selected based on the frequency separation point FS. In step S712, a Doppler FFT process is applied to the second sideband signal (the lower sideband signal LS) to obtain vital sign information IV. For a detailed process, reference is made to the foregoing description.

Further, in step S600, sensing information IS is calculated based on the delay time. As described above, the sensing information IS is determined based on the second difference.

In some embodiments, no order of execution exists between step S711 to step S712 and step S312 to step S313. In some embodiments, no order of execution exists between step S500 and step S600.

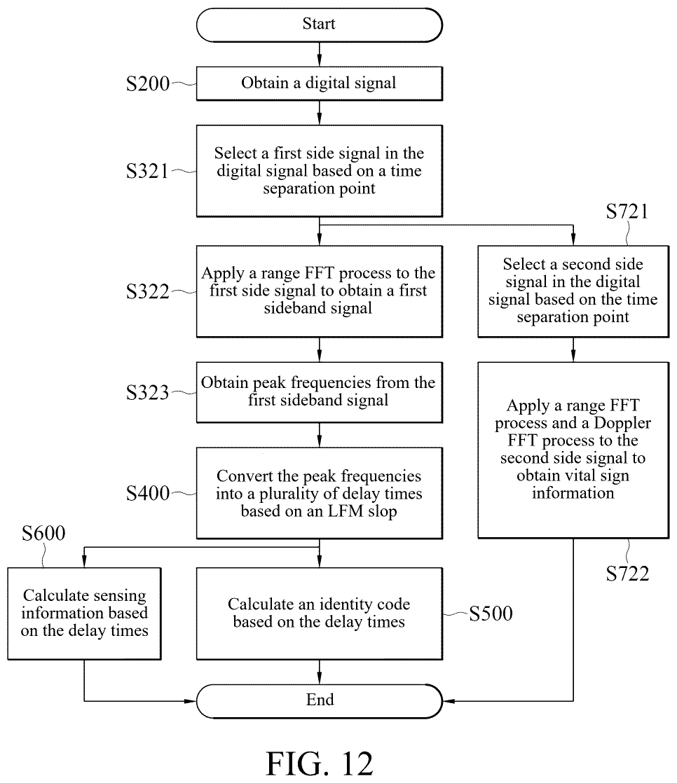

FIG. 12 is a detailed flowchart of a method for decoding an identity code from a radar echo according to another embodiment of the present invention. Compared with division of the digital signals SD into two parts based on the frequency separation point FS in FIG. 11, in this embodiment, the digital signals SD are divided into two parts based on a time separation point TS. As shown in FIG. 3B, the time separation point TS may be obtained by converting the frequency separation point FS through the LFM slope S. Only a difference from FIG. 11 is described herein. Refer to FIG. 2, FIG. 3C, FIG. 3D, and FIG. 12 together. The foregoing step S300 includes step S321 to step S323. In step S321, a first side signal (the following portion signal FP of the matrix A1 as shown in FIG. 2) in the digital signals SD is selected based on the time separation point TS, for example, the delay times TD2 and TD3 shown in FIG. 3D. In step S322, the range FFT process is applied to the first side signal (the following portion signal FP) to obtain a first sideband signal (the upper sideband signal US of the matrix A2 as shown in FIG. 2). In step S323, the peak frequencies (the frequency differences ΔF2 and ΔF3 as shown in FIG. 3C) are obtained from the first sideband signal (the upper sideband signal US).

Further, in step S721, a second side signal (a preceding portion signal PP) in the digital signals SD is selected based on the time separation point TS. In step S722, the range FFT process and a Doppler FFT process are applied to the second side signal (the preceding portion signal PP) to obtain vital sign information IV. For a detailed process, reference is made to the foregoing description.

In some embodiments, no order of execution exists between step S711 to step S712 and step S312 to step S313.

The foregoing processes of FIG. 11 and FIG. 12 are particularly applicable to a case in which different chirp signals C1-Cn are to be used for different to-be-detected targets, and only to-be-detected information from the first part or the second part or only the corresponding part may be processed. As shown in FIG. 7 and FIG. 8, the first part of the digital signals SD corresponding to the first time slot T1 is selected based on the time separation point TS or the frequency separation point FS, and the identity code IN and the sensing information IS are calculated accordingly. The second part of the digital signals SD corresponding to the second time slot T2 is selected based on the time separation point TS or the frequency separation point FS, and the vital sign information IV is calculated accordingly. In this way, not all of the digital signals SD need to be processed in each time slot, which may save efficiency and improve operation efficiency.

In some embodiments, the foregoing sensor 200 is arranged at any position of the foregoing creature 300.

In some embodiments, the frequency separation point FS is approximately equal to 25 MHz or 50 MHz, which may respectively correspond to the time separation point TS of 0.5 microseconds or 1 microsecond. A possible range of the frequency separation point FS or the time separation point TS is obtained based on a plurality of experimental results, which facilitates improvement of determination precision of distinguishing between the digital signals SD.

According to the FMCW radar 100 with an identity recognition function and the method for decoding identity codes from radar echoes SR and SS of some embodiments of the present invention, the identity code IN may be obtained by using a radar echo SS of a sensor 200 already worn by a subject and existing in a same radar system, without the need for the subject to wear an additional identity recognition device that does not belong to the radar system. Further, in addition to identity recognition, the sensing information IS and the vital sign information IV of the sensor 200 may be detected through the same radar system.

What is claimed is:

1. A frequency modulated continuous wave (FMCW) radar with an identity recognition function, comprising:
a processing module, configured to demodulate a radar echo corresponding to a radar signal to generate a digital signal; and
an operation module, coupled to the processing module and configured to:
apply a range fast Fourier transform (FFT) process to the digital signal to obtain a plurality of peak frequencies;
convert the peak frequencies into a plurality of delay times based on a linear frequency-modulated (LFM) slope; and
calculate an identity code based on the delay times.

2. The FMCW radar with an identity recognition function according to claim 1, wherein the delay times comprise a first reference time, a second reference time, and a plurality of mark times, a first difference exists between each of the mark times and the first reference time, a second difference exists between the first reference time and the second reference time, and the identity code is calculated based on a ratio of each of the first differences to the second difference.

3. The FMCW radar with an identity recognition function according to claim 2, wherein the operation module is further configured to determine sensing information based on the second difference.

4. The FMCW radar with an identity recognition function according to claim 1, wherein the applying a range FFT process to the digital signal comprises:
selecting a first side signal in the digital signal based on a time separation point;
applying the range FFT process to the first side signal to obtain a first sideband signal; and
obtaining the peak frequencies from the first sideband signal.

5. The FMCW radar with an identity recognition function according to claim 4, wherein the operation module is further configured to:
select a second side signal in the digital signal based on the time separation point; and
apply the range FFT process and a Doppler FFT process to the second side signal to obtain vital sign information.

6. The FMCW radar with an identity recognition function according to claim 1, wherein the applying a range FFT process to the digital signal comprises:
applying the range FFT process to the digital signal to obtain a conversion result;
selecting a first sideband signal in the conversion result based on a frequency separation point; and
obtaining the peak frequencies from the first sideband signal.

7. The FMCW radar with an identity recognition function according to claim 6, wherein the operation module is further configured to:
select a second sideband signal in the conversion result based on the frequency separation point; and
apply a Doppler FFT process to the second sideband signal to obtain vital sign information.

8. The FMCW radar with an identity recognition function according to claim 1, wherein the radar signal has different LFM parameters in a first time slot and a second time slot.

9. The FMCW radar with an identity recognition function according to claim 8, wherein the operation module is further configured to:
select a first part of the digital signal corresponding to the first time slot based on a time separation point or a frequency separation point, and calculate the identity code accordingly; and
select a second part of the digital signal corresponding to the second time slot based on the time separation point or the frequency separation point, and calculate vital sign information accordingly.

10. The FMCW radar with an identity recognition function according to claim 1, further comprising:
a signal generator, configured to generate an LFM radar signal;
a transmission module, coupled to the signal generator and configured to transmit the radar signal to a sensor; and
a receiving module, coupled to the transmission module and configured to receive the radar echo corresponding to the radar signal from the sensor, wherein
the sensor is a surface acoustic wave (SAW) sensor.

11. A method for decoding an identity code from a radar echo, performed by an operation device, and comprising:
obtaining a digital signal;
applying a range FFT process to the digital signal to obtain a plurality of peak frequencies;
converting the peak frequencies into a plurality of delay times based on an LFM slope; and
calculating an identity code based on the delay times.

12. The method for decoding an identity code from a radar echo according to claim 11, wherein the delay times comprise a first reference time, a second reference time, and a plurality of mark times, a first difference exists between each of the mark times and the first reference time, a second difference exists between the first reference time and the second reference time, and the identity code is calculated based on a ratio of each of the first differences to the second difference.

13. The method for decoding an identity code from a radar echo according to claim 12, further comprising:
determining sensing information of a sensor based on the second difference, wherein the radar echo comes from the sensor.

14. The method for decoding an identity code from a radar echo according to claim 13, wherein the digital signal is generated by a FMCW radar through demodulation after receiving the radar echo, the radar echo corresponds to an LFM radar signal, and the sensor is a SAW sensor.

15. The method for decoding an identity code from a radar echo according to claim 11, wherein the applying a range FFT process to the digital signal comprises:
selecting a first side signal in the digital signal based on a time separation point;
applying the range FFT process to the first side signal to obtain a first sideband signal; and
obtaining the peak frequencies from the first sideband signal.

16. The method for decoding an identity code from a radar echo according to claim 15, further comprising:
selecting a second side signal in the digital signal based on the time separation point; and
applying the range FFT process and a Doppler FFT process to the second side signal to obtain vital sign information.

17. The method for decoding an identity code from a radar echo according to claim 11, wherein the applying a range FFT process to the digital signal comprises:
applying the range FFT process to the digital signal to obtain a conversion result;
selecting a first sideband signal in the conversion result based on a frequency separation point; and
obtaining the peak frequencies from the first sideband signal.

18. The method for decoding an identity code from a radar echo according to claim 17, further comprising:
selecting a second sideband signal in the conversion result based on the frequency separation point; and
applying a Doppler FFT process to the second sideband signal to obtain vital sign information.

19. The method for decoding an identity code from a radar echo according to claim 14, wherein the radar signal has different LFM parameters in a first time slot and a second time slot.

20. The method for decoding an identity code from a radar echo according to claim 19, further comprising:
selecting a first part of the digital signal corresponding to the first time slot based on a time separation point or a frequency separation point, and calculating the identity code accordingly; and
selecting a second part of the digital signal corresponding to the second time slot based on the time separation point or the frequency separation point, and calculating vital sign information accordingly.
